(19) United States
(12) Patent Application Publication
(10) Pub. No.: US 2026/0265129 A1
(43) Pub. Date: Sep. 10, 2026

(54) SYSTEMS AND METHODS FOR MANUFACTURING CALCINED GYPSUM WITH REDUCED PARTICLE SIZE AND MANUFACTURING GYPSUM BOARD WITH SAME

(71) Applicant: United States Gypsum Company, Chicago, IL (US)

(72) Inventors: Naser Aldabaibeh, Homer Glen, IL (US); Mark K. Hemphill, Hawthorn Woods, IL (US); Ali Pournaghshband Isfahani, Gurnee, IL (US)

(73) Assignee: United States Gypsum Company, Chicago, IL (US)

(21) Appl. No.: 19/559,620

(22) Filed: Mar. 6, 2026

Related U.S. Application Data
(60) Provisional application No. 63/769,486, filed on Mar. 10, 2025.

(51) Int. Cl. C04B 11/028; B01J 6/00; B28C 7/00; C04B 11/00; B28B 19/00; C04B 111/00

(52) U.S. Cl. CPC C04B 11/028; B01J 6/001; B28C 7/003; C04B 11/007; B28B 19/0092; C04B 2111/0062

(57) ABSTRACT

Embodiments of a system and a method for manufacturing calcined gypsum and for manufacturing a gypsum board can include a grinding system with a roller mill configured to reduce the particle size of calcined gypsum to an average particle size of fifteen microns or less. The grinding system can be located in one of the stucco or gypsum board manufacturing systems or distributed between the two systems.

### CROSS-REFERENCE TO RELATED APPLICATION

This patent application claims the benefit of priority to U.S. Provisional Patent Application No. 63/769,486, filed Mar. 10, 2025, and entitled, “Systems and Methods for Manufacturing Calcined Gypsum With Reduced Particle Size and Manufacturing Gypsum Board With Same,” which is incorporated in its entirety herein by this reference.

### BACKGROUND

The present disclosure relates to systems and methods for calcining gypsum and for manufacturing gypsum board, such as, e.g., in continuous cementitious board manufacturing processes, and, more particularly, to systems and methods for calcining gypsum and manufacturing gypsum board which include processing gypsum to have a reduced particle size (e.g., an average particle size below fifteen microns).

Calcium sulfate materials are available in several forms or phases that are simplified as follows: calcium sulfate dihydrate—CaSO₄∙2H₂O (commonly known as gypsum); calcium sulfate hemihydrate—CaSO₄∙½H₂O (commonly known as stucco); and calcium sulfate—CaSO₄ (commonly known as anhydrite). In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Patent No. 5,320,677, for example. Typically, such gypsum-containing cementitious products are made by preparing a mixture of calcined gypsum (comprising calcium sulfate hemihydrate alpha or beta and/or calcium sulfate anhydrite), water, and other components, as appropriate to form cementitious slurry. The cementitious slurry and desired additives are often blended in a continuous mixer, as described in U.S. Patent No. 3,359,146, for example.

The mixture typically is cast into a pre-determined shape or onto the surface of a substrate. The calcined gypsum reacts with the water to form a matrix of crystalline hydrated gypsum, i.e., calcium sulfate dihydrate. It is the desired hydration of calcined gypsum that enables the formation of an interlocking matrix of set gypsum, thereby imparting strength to the gypsum structure in the gypsum-containing product.

Calcined gypsum is typically made by crushing gypsum rock to form land plaster and then heating the gypsum at atmospheric pressure to calcine (dehydrate) the calcium sulfate dihydrate into preferably calcium sulfate hemihydrate. In addition to natural gypsum rock, the use of synthetic gypsum, such as, e.g., flue gas desulphurization gypsum or gypsum from chemical processes can be used as well. The calcining of gypsum typically occurs in a large atmospheric pressure kettle containing a mixture of the various phases of the gypsum.

When gypsum, (i.e., calcium sulfate dihydrate) is calcined, water is removed from the calcium sulfate molecular structure. When one and a half molecules of water are removed from the molecular structure of gypsum, the hemihydrate results, a material used in various compositions in which rehydration occurs during the setting process subsequent to the addition of the water. When two molecules of water are removed from the molecular structure of gypsum, the anhydrite results. Anhydrites formed by calcining at low temperatures are able to rehydrate when exposed to moist conditions.

Gypsum (CaSO₄∙2H₂O) powder, which can be referred to as “land plaster” and can come from sources such as rocks of natural gypsum crushed to make gypsum powder or synthetic gypsum made to be a powder, can be heated to calcine into stucco, such as by being heated to a temperature of generally about 250° F–360° F. With appropriate thermal energy, the gypsum powder converts to hemihydrate (CaSO₄∙½H₂O). If the hemihydrate is exposed to even greater thermal energy, the gypsum can convert to soluble anhydrite (CaSO₄) or insoluble anhydrite (often referred to as “dead burn”). At great enough exposure to thermal energy, some of the CaSO₄ converts to CaO (quicklime), increasing the pH of the dead burn. When calcining gypsum via a process reactor, the primary control mechanism to maintain quality is typically to maintain a material (e.g., stucco) output temperature, of which the material feed to the calciner and/or the heat to the calciner is manipulated to maintain the calciner output control.

In a typical cementitious board manufacturing process such as gypsum wallboard, cementitious board is produced by dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. A stream of foamed slurry passes through the discharge conduit from which it is continuously deposited onto a moving web of cover sheet material (i.e., the face sheet) supported by a forming table. The foamed slurry is allowed to spread over the advancing face sheet. A second web of cover sheet material (i.e., the back sheet) is applied to cover the foamed slurry and form a sandwich structure of a continuous wallboard preform. The wallboard preform is subjected to forming, such as at a conventional forming station, to obtain a desired thickness.

The calcined gypsum reacts with the water in the wallboard preform to form a matrix of crystalline hydrated gypsum or calcium sulfate dihydrate and sets as a conveyor moves the wallboard preform down the manufacturing line. The hydration of the calcined gypsum provides for the formation of an interlocking matrix of set gypsum, thereby imparting strength to the gypsum structure in the gypsum-containing product. The product slurry becomes firm as the crystal matrix forms and holds the desired shape.

The quality of the calcined gypsum can have an influence on the crystalline matrix formation. The phase composition of the calcined gypsum may call for the adjustment of the concentration of one or more of the various additives known to for use in the board formulation.

After the wallboard preform is cut into segments downstream of the forming station at a point along the line where the preform has set sufficiently, the segments are flipped over, dried (e.g., in a kiln) to drive off excess water, and processed to provide the final wallboard product of desired dimensions. The aqueous foam produces air voids in the set gypsum, thereby reducing the density of the finished product relative to a product made using a similar slurry but without foam. Prior devices and methods for addressing some of the operational problems associated with the production of gypsum wallboard are disclosed in commonly-assigned U.S. Patent Nos. 5,683,635; 5,643,510; 6,494,609; 6,874,930; 7,007,914; and 7,296,919, which are incorporated by reference.

There is a continued need in the art to provide additional solutions to enhance the production of cementitious articles. For example, there is a continued need for techniques for producing calcined gypsum that require less water to produce a board and yield a board with good strength.

It will be appreciated that this background description has been created to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for manufacturing calcined gypsum. In embodiments, a system for manufacturing calcined gypsum includes a grinding system having a rotor mill.

In one embodiment, a system for manufacturing calcined gypsum includes a calcination unit and a grinding system. The calcination unit includes a calcining chamber and a heating unit associated with the calcining chamber. The calcining chamber includes an inlet for receiving a supply of gypsum therethrough and into the calcining chamber and an outlet for discharging the supply of gypsum from the calcining chamber. The grinding system includes a rotor mill in at least one of a position upstream of the inlet of the calcining chamber and a position downstream of the outlet of the calcining chamber. The rotor mill is configured to grind the supply of gypsum to an average particle size of fifteen microns or less.

In another aspect, the present disclosure describes embodiments of a method of manufacturing calcined gypsum. In embodiments, a method of manufacturing calcined gypsum includes grinding gypsum to an average particle size of fifteen microns or less.

In yet another aspect, the present disclosure is directed to embodiments of a system for manufacturing a gypsum board. In embodiments, a system for manufacturing a gypsum board includes a grinding system having a rotor mill.

In one embodiment, a system for manufacturing a gypsum board includes a mixer, an ingredient supply system, and a grinding system. The mixer is adapted to agitate calcined gypsum and water to form an aqueous gypsum slurry. The ingredient supply system is configured to selectively feed at least water and calcined gypsum to the mixer. The ingredient supply system includes a source of calcined gypsum. The grinding system includes a rotor mill interposed between the source of calcined gypsum and the mixer. The rotor mill is configured to grind calcined gypsum from the source of calcined gypsum to an average particle size of fifteen microns or less to selectively deliver a feed stream of ground calcined gypsum to the mixer.

In still another aspect, the present disclosure describes embodiments of a method of manufacturing a gypsum board. In embodiments, a method of manufacturing a gypsum board includes grinding gypsum to an average particle size of fifteen microns or less.

In one embodiment, a method of manufacturing a gypsum board includes grinding a supply of calcined gypsum in a rotor mill such that a feed stream of ground calcined gypsum having an average particle size of fifteen microns or less is produced. The feed stream of ground calcined gypsum is delivered to a mixer. At least water and the feed stream of ground calcined gypsum is agitated in the mixer to form an aqueous gypsum slurry.

Further and alternative aspects and features of the disclosed principles will be appreciated from the following detailed description and the accompanying drawings. As will be appreciated, the systems and techniques for manufacturing calcined gypsum and gypsum boards that are disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic plan diagram of an embodiment of a system for manufacturing calcined gypsum constructed in accordance with principles of the present disclosure and an embodiment of a system for manufacturing a gypsum board constructed in accordance with principles of the present disclosure that includes an embodiment of a gypsum slurry mixing and dispensing assembly constructed in accordance with principles of the present disclosure.

FIG. 2 is a plot of the water/stucco ratio of various gypsum samples to satisfy a seven-inch slump test.

FIGS. 3A-C are plots of particle size versus percentage of particles showing a particle size distribution for various gypsum samples.

FIGS. 4A-D are plots of the compressive strength of various gypsum samples.

It should be understood that the drawings are not necessarily to scale and that the disclosed embodiments are illustrated diagrammatically and in partial views. In certain instances, details which are not necessary for an understanding of this disclosure, or which render other details difficult to perceive have been omitted. It should be understood that this disclosure is not limited to the particular embodiments illustrated herein.

### DETAILED DESCRIPTION OF EXEMPLARY EMBODIMENTS

The present disclosure provides various embodiments of systems for manufacturing calcined gypsum and systems for manufacturing a gypsum board that include a grinding system configured to produce gypsum with a reduced particle size. In embodiments, the grinding system comprises a rotor mill that is configured to provide a consistent, continuous flow of ground calcined gypsum having an average particle size of fifteen microns or less with reduced operational variation. In embodiments, the grinding system includes a rotor mill in series with an impact mill.

The present disclosure also provides various embodiments of a system and a method for at least one of manufacturing calcined gypsum and manufacturing a gypsum board that respectively include means and a step for grinding calcined gypsum to an average particle size of fifteen microns or less. In embodiments, the means and step for grinding calcined gypsum to an average particle size of fifteen microns or less can comprise a rotor mill. Embodiments of systems and methods for manufacturing calcined gypsum and/or a gypsum board following principles of the present disclosure include a grinding system constructed according to principles of the present disclosure.

In embodiments, the grinding system comprises any suitable rotor mill useful in reducing the particle size of calcined gypsum to an average particle size of fifteen microns or less. In embodiments, the rotor mill is configured to reduce the particle size of calcined gypsum to an average particle size in a range from five to fifteen microns For example, in embodiments, the rotor mill comprises any commercially-available rotor mill suitable for grinding gypsum in various forms including rock, land plaster, and stucco to an average particle size of fifteen microns or less. In embodiments, the rotor mill comprises a “Long Gap Mill” having a long annular gap path through which the gypsum takes from the inlet to the discharge. In embodiments, the rotor mill comprises a commercially-available rotor mill from Prater Industries of Bolingbrook, Illinois.

In embodiments, the grinding system comprises any suitable rotor mill and any suitable impact mill. In embodiments, the impact mill is configured to reduce the particle size of the gypsum to an average particle size of fifty microns or less. In embodiments, the impact mill comprises any commercially-available impact mill suitable for grinding gypsum in various forms including rock, land plaster, and stucco to an average particle size between twenty and fifty microns. In embodiments, the impact mill comprises a commercially-available impact mill from Entoleter LLC of Hamden, Connecticut.

In embodiments, a grinding system constructed according to principles of the present disclosure can comprise a part of a system for manufacturing calcined gypsum housed in a mill. The calcined gypsum can be ground to an average particle size of fifteen microns or less as part of manufacturing the calcined gypsum.

In embodiments, a grinding system constructed according to principles of the present disclosure can comprise a part of a system for manufacturing gypsum board housed in a boardline manufacturing facility. Calcined gypsum can be fed to the boardline and ground to an average particle size of fifteen microns or less as part of manufacturing the gypsum board so that the calcined gypsum is freshly cut shortly before being used to manufacture gypsum board.

In embodiments, the use of a grinding system constructed according to principles of the present disclosure to grind the stucco stream being produced/fed to the boardline according to principles of the present disclosure can enhance the usage of constituent materials comprising the board formulation with decreased water demand and good strength suitable for the board’s intended application.

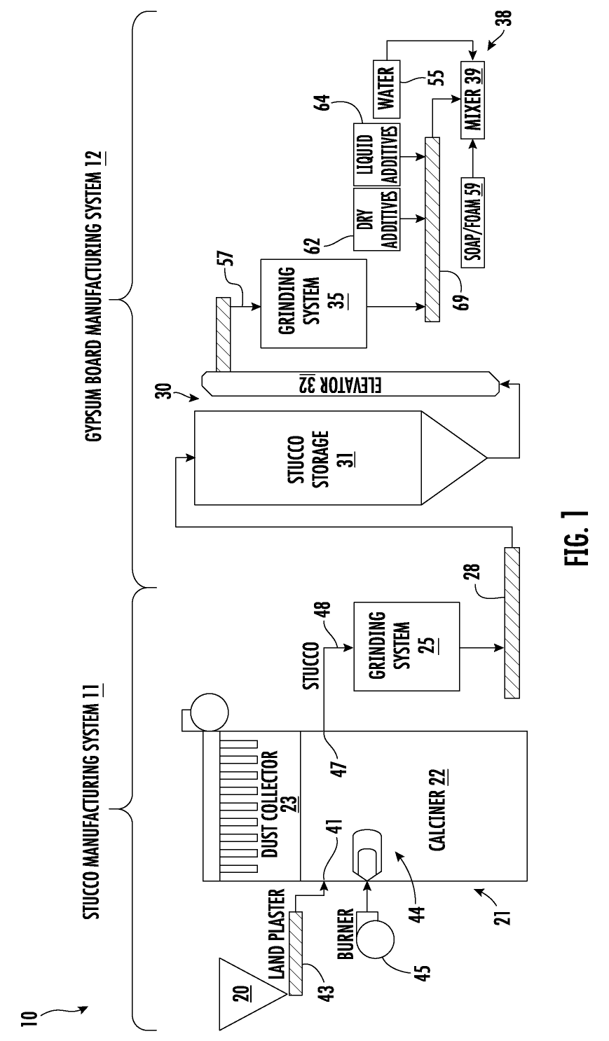

Turning now to the Figures, an embodiment of a system 10 for manufacturing calcined gypsum and for manufacturing a gypsum board constructed in accordance with principles of the present disclosure is shown diagrammatically. The system 10 illustrated in FIG. 1 includes a system 11 for manufacturing calcined gypsum and a system 12 for manufacturing a gypsum board together to form an integrated manufacturing environment.

In embodiments, the system 11 for manufacturing calcined gypsum and the system 12 for manufacturing a gypsum board are housed in separate facilities. The illustrated system 11 for manufacturing calcined gypsum includes a source of gypsum 20 in the form of land plaster powder, a calcination unit 21 comprising a calciner 22 with an associated dust collector 23, a grinding system 25 constructed according to principles of the present disclosure, and a discharge conveyor 28. It will be understood by one skilled in the art that the system 11 for manufacturing calcined gypsum can include other components and equipment, including, e.g., analyzers, control devices, and material handling equipment.

The illustrated system 12 for manufacturing a gypsum board includes an ingredient supply system 30 having a stucco bin 31 and an elevator 32, a grinding system 35 constructed according to principles of the present disclosure, and a wet end assembly 38 that includes a mixer 39. It will be understood by one skilled in the art that the system 12 for manufacturing a gypsum board can include other known subsystems of a gypsum boardline that are not shown in FIG. 1, including, e.g., a forming station, a cutting station, a kiln, and suitable conveying equipment downstream of the wet end equipment shown in FIG. 1.

In embodiments following principles of the present disclosure, a system for manufacturing calcined gypsum or a system for manufacturing gypsum board constructed according to principles of the present disclosure is provided on its own. In embodiments including both a system for manufacturing calcined gypsum and a system for manufacturing gypsum board, the grinding system can be omitted from one of them or distributed between the different facilities housing the systems.

With respect to the system 11 for manufacturing calcined gypsum, in embodiments, the source of gypsum 20 can be any suitable gypsum, such as, for example land plaster. In embodiments, the source of gypsum 20 is arranged with an inlet 41 of the calciner 22 to provide a feed stream of gypsum to the calciner 22. In the illustrated embodiment, the source of gypsum 20 is associated with a feeder conveyor 43 to selectively deliver the supply of gypsum powder to the calciner 22 via the feeder conveyor 43. The feeder conveyor 43 is configured to direct the feed stream from the gypsum source 20 to a calcining chamber 44 of the calciner 22 via the inlet 41.

In embodiments, the calcination unit 21 includes the calcining chamber 44 and a heating unit 45 associated with the calcining chamber 44 to provide heat for calcination. The calcining chamber 44 includes the inlet 41 for receiving a supply of gypsum therethrough and into the calcining chamber 44 and an outlet 47 for discharging a discharge stream 48 of calcined gypsum (generally referred to as “stucco”) from the calcining chamber 44.

In embodiments, the calcination unit 21 can comprise any suitable calcination unit, including any suitable commercially-available calciner as one skilled in the art would appreciate, such as, a suitable kettle or flash calciner, for example. Exemplary calcining units comprise kettles, which may be indirectly heated, roller mills, ball mills, and hammer mills. In embodiments, the heating unit 45 of the calcination unit 21 includes at least one burner. Each burner can be operated using any suitable fuel, such as, natural gas, petroleum gas, oil, coal, etc. Fuel and air can be introduced to each burner of the heating unit 45 to be burned and the hot gases are then provided in the calcining chamber 44.

The dust collector 23 is arranged with the calciner 22 to collect dust emitted therefrom. In embodiments, the dust collector 23 can be any suitable dust collector suitable for abating the amount of dust emitted from the calciner 22.

In the illustrated embodiment, the grinding system 25 is arranged with the discharge stream 48 of the calciner 22 so that the discharge stream 48 passes therethrough. In embodiments, the grinding system 25 is arranged so that the discharge stream 48 of the calciner 22 passes through the grinding system 25 to process the calcined gypsum to a desired particle size range.

In embodiments, the grinding system 25 comprises any suitable rotor mill useful in reducing the particle size of calcined gypsum to an average particle size of fifteen microns or less. For example, in embodiments, the rotor mill comprises any commercially-available rotor mill suitable for grinding gypsum in various forms including rock, land plaster, and stucco to an average particle size of fifteen microns or less. In embodiments, the rotor mill comprises a “Long Gap Mill” having a long annular gap path through which the gypsum takes from the inlet to the discharge. In embodiments, the rotor mill comprises a commercially-available rotor mill from Prater Industries of Bolingbrook, Illinois.

In embodiments, the grinding system 25 comprises a rotor mill having a long annular gap path and being configured to grind and mill the calcined gypsum via particle-on-particle collisions within a turbulent environment generated by a rotor which spins at sufficiently high speed. In embodiments, the rotating component of the rotor can be supported a rotor shaft which has bearings located at each end thereof. The bearings can be located outside of a grinding chamber within which the rotating component of the rotor is located.

In embodiments, the rotor mill can include a lower section and an upper section. The lower section includes a material distribution fan configured to provide air flow through the rotor mill. The rotor mill can be configured so that the fan is configured to accelerate and distribute the feed material upstream of the entry into the grinding chamber.

The upper section includes the grinding chamber and the rotating component which is housed within the grinding chamber. In embodiments, the rotating component of the rotor comprises several stages containing grinding plates. The grinding plates can be configured to rotate to accelerate the air within the grinding chamber and to cause the air to interact with a grooved lining within the grinding chamber, thereby creating pockets of rotating air at high velocities. The operation of the rotating component of the rotor mill is configured to create an air stream within the grinding chamber that causes the particles of calcined gypsum to collide with each other to grind the calcined gypsum to a desired average particle size. In embodiments, the grinding plates and rotational parameters can be adjusted to achieve calcined gypsum with a desired particle size distribution.

In embodiments, the rotor mill is configured to grind gypsum to an average particle size of fifteen microns or less. In embodiments, the rotor mill is configured to grind gypsum to an average particle size in a range from five to fifteen microns, and in a range from eight to fifteen microns in still other embodiments. In embodiments, the rotor mill is configured to grind gypsum to such that more than fifty percent of the gypsum particles are twelve microns or less, and, in other embodiments, more than fifty percent of the gypsum particles are ten microns or less.

In embodiments, the grinding system 25 comprises any suitable rotor mill and any suitable impact mill arranged in series with each other such that the supply of gypsum moves serially through the rotor mill and the impact mill. In embodiments, the rotor mill can be upstream of the impact mill or vice versa.

In embodiments, the impact mill comprises any commercially-available impact mill suitable for grinding gypsum in various forms including rock, land plaster, and stucco to an average particle size between twenty and fifty microns. In embodiments, the impact mill comprises a commercially-available impact mill from Entoleter LLC of Hamden, Connecticut.

The grinding system 25 can be configured to grind and/or mill the calcined gypsum to a desired particle size range. The grinding system 25 can be located upstream or downstream of the calcination unit 21. In embodiments, the grinding system 25 can be incorporated as a stage into a single unit for calcining and milling/grinding. In the illustrated embodiment, the grinding system is disposed downstream of the calcining unit 21. In other embodiments, the grinding system can be disposed upstream of the calcining unit 21.

In embodiments, the system 11 for manufacturing calcined gypsum can be used with a variety of calcium sulphate materials, to produce a discharge stream 48 from the grinding system 25 comprising one or more of the following: water-soluble calcium sulfate anhydrite, calcium sulfate α-hemihydrate, calcium sulfate β-hemihydrate, natural, synthetic or chemically modified calcium sulfate hemihydrate, calcium sulfate dihydrate, and mixtures thereof. In one aspect, the discharge stream 48 desirably comprises calcined gypsum, such as in the form of calcium sulfate alpha hemihydrate, calcium sulfate beta hemihydrate, and/or calcium sulfate anhydrite. The calcined gypsum can be fibrous in some embodiments and nonfibrous in other embodiments. In embodiments, the calcined gypsum can include at least about 50% beta calcium sulfate hemihydrate. In other embodiments, the calcined gypsum can include at least about 86% beta calcium sulfate hemihydrate.

In the illustrated embodiment, calcined gypsum can be discharged in the discharge stream 48 from the calcination unit 21 through the grinding system 25 to the discharge conveyor 28. In the illustrated embodiment, the discharge conveyor 28 transports the discharge stream 48 of calcined gypsum from the calcination unit 21 to the stucco bin 31. In other embodiment, the calcined gypsum can be transported directly to the boardline without passing through a stucco bin. The discharge stream 48 from the calciner 22 can be fed through the grinding system 25 for processing to a desired particle size distribution and to the stucco bin 31 (if present) for storage until the boardline calls for a supply of stucco.

With respect to the system 12 for manufacturing a gypsum board, in embodiments, the ingredient supply system 30 is configured to selectively feed, according to a board formulation, at least water 55 and a feed stream 57 of calcined gypsum to at least one inlet of the mixer 39. The illustrated ingredient supply system 30 includes a source of calcined gypsum 31 associated with the mixer 39 to selectively deliver the feed stream 57 of calcined gypsum to at least one inlet of the mixer 39, a source of water 55, a source of soap/foam 59, a source of at least one dry additive 62, and a source of at least one liquid additive 64. In embodiments, the ingredient supply system 30 can include a foam generator system suitable for delivering the supply of foam 59 to the mixer 39 and/or discharge conduit of the mixer 39 as is well understood by one skilled in the art. In other embodiments, the ingredient supply system 30 can include any suitable dry ingredient and/or suitable liquid ingredient as will be appreciated by one skilled in the art.

The illustrated ingredient supply system 30 includes the stucco bin 31 and the elevator 32. The stucco bin 31 is associated with the elevator 32 in order to selectively supply the wet end assembly 38 with the feed stream 57 of calcined gypsum. The elevator 32 is disposed between the stucco bin 31 and the second analyzer 37. The elevator 32 is configured to receive the feed stream 57 of calcined gypsum from the stucco bin 31, convey the feed stream 57 of calcined gypsum from the stucco bin 31 to an elevated position, and discharge the feed stream 57 of calcined gypsum therefrom so that the feed stream 57 can be conveyed through the grinding system 35 to the mixer 39. In embodiments, the ingredient supply system 30 includes a suitable device 69 such as an auger, screw, or similar device for incorporating together the feed stream 57 of calcined gypsum and at least one other ingredient of the board formulation for introduction into the mixer 39 and appropriate conveyor and/or ductwork for facilitating the conveyance of at least one ingredient to an inlet of the mixer 39. In the illustrated embodiment, the grinding system 35 is disposed between the elevator 32 and the auger 69.

The grinding system 35 can be configured to grind and/or mill the calcined gypsum to a desired particle size range. In embodiments, the grinding system 35 comprises any suitable rotor mill useful in reducing the particle size of calcined gypsum to an average particle size of fifteen microns or less. In embodiments, the grinding system 35 comprises any suitable rotor mill and any suitable impact mill arranged in series with each other. In embodiments, the rotor mill can be upstream of the impact mill or vice versa.

In embodiments, the grinding system 35 can be similar to the grinding system 25 of the stucco manufacturing system 11. In embodiments, when the gypsum board manufacturing system 12 includes the grinding system 35, the grinding system 25 of the stucco manufacturing system 11 can be omitted. In embodiments, when the stucco manufacturing system 11 includes the grinding system 25, the grinding system 35 of the gypsum board manufacturing system 12 can be omitted.

In embodiments, the grinding system 25 of the stucco manufacturing system 11 includes a suitable impact mill, and the grinding system 35 of the gypsum board manufacturing system 12 includes a suitable rotor mill. In embodiments, the grinding system 25 of the stucco manufacturing system 11 includes a suitable impact mill configured to grind stucco to an average particle size between twenty and fifty microns, and the grinding system 35 of the gypsum board manufacturing system 12 includes a suitable rotor mill configured to grind stucco to an average particle size of fifteen microns or less.

In embodiments, the wet end assembly 38 can include any suitable equipment adapted to mix and/or assemble the constituent materials forming the gypsum board. In embodiments, the mixer 39 is adapted to agitate at least calcined gypsum and water to form an aqueous gypsum slurry. The mixer 39 is adapted to agitate the feed stream 57, the water 55, and other known additives supplied by the ingredient supply system 30 to form an aqueous gypsum slurry which is configured to form the core of the gypsum board. In embodiments, the mixer 39 includes a housing and an agitator disposed within the housing. The agitator can be configured to agitate water and calcined gypsum to form an aqueous gypsum slurry. In embodiments, the housing has at least one inlet for delivering the water and the calcined gypsum to the mixer 39 and an outlet for discharging the aqueous gypsum slurry from the housing of the mixer 39.

In embodiments, the housing defines a mixing chamber, a water inlet, and a calcined gypsum inlet. The water inlet and the calcined gypsum inlet are in communication with the mixing chamber. In embodiments, the housing defines a plurality of water inlets that are arranged near the calcined gypsum inlet. In embodiments, the housing defines one or more other water inlets located closer to the radial periphery of the housing. In embodiments, the housing defines at least one additive inlet for receiving an additive therethrough.

In embodiments, the mixer 39 is in fluid communication with a discharge conduit and the foam injection system 59. Both the water and the stucco stream can be supplied to the mixer 39 via one or more inlets as is known in the art. In embodiments, any other suitable slurry additive can be supplied to the mixer 39. The weight ratio of water to calcined gypsum can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as in a range between about 1:6 and about 1:1, e.g., about 2:3.as is known in the art of manufacturing cementitious products.

In embodiments, one or more inlets can be provided for introducing other additives from the ingredient supply system 30 into the mixer 39 in addition to foam that are commonly used in the production of gypsum board. Such additives include structural additives including mineral wool, continuous or chopped glass fibers (also referred to as fiberglass), perlite, clay, vermiculite, calcium carbonate, polyester, and paper fiber, as well as chemical additives such as foaming agents, fillers, accelerators, sugar, enhancing agents such as phosphates, phosphonates, borates and the like, retarders, binders (e.g., starch and latex), colorants, fungicides, biocides, hydrophobic agent, such as a silicone-based material (e.g., a silane, siloxane, or silicone-resin matrix), and the like. Examples of the use of some of these and other additives are described, for instance, in U.S. Patent Nos. 6,342,284; 6,632,550; 6,800,131; 5,643,510; 5,714,001; and 6,774,146; and U.S. Patent Application Publication Nos. 2002/0045074; 2004/0231916; 2005/0019618; 2006/0035112; and 2007/0022913.

In embodiments, any suitable mixer (e.g., a pin mixer) can be used in the wet end. In embodiments, the mixer can be a suitable, commercially-available mixer, as is known in the gypsum board manufacturing art, such as, one available from Gypsum Technologies Inc. or John Broeders Machine both of Ontario, Canada, for example.

In embodiments, the agitator is rotatably mounted within the mixing chamber. The agitator can include a radially extending disc to which is attached a generally vertical drive shaft positioned along a normal axis, which is perpendicular to both a machine direction and a cross-machine direction. The drive shaft can extend through the upper wall of the main mixer. The drive shaft can be connected to a conventional drive source, such as, a motor, for example, for rotating the drive shaft at a suitable speed (e.g., 275-300 rpm) appropriate for rotating the agitator to mix the contents of the mixing chamber of the main mixer. This rotation directs the resulting aqueous slurry in a generally centrifugal direction, such as in a clockwise outward spiral. It should be appreciated that this discussion of an agitator is meant only to indicate the basic principles of agitators commonly employed in gypsum slurry mixing chambers known in the art. Alternative agitator designs, including those employing pins, paddles, plows, rings, etc., are contemplated.

In embodiments, the weight ratio of water to calcined gypsum can be any suitable ratio, although, as one of ordinary skill in the art will appreciate, lower ratios can be more efficient because less excess water will remain after the hydration process of the stucco is completed to be driven off during manufacture, thereby conserving energy. In some embodiments, the gypsum slurry can be prepared by combining water and calcined gypsum in a suitable water to stucco weight ratio for board production depending on products, such as in a range between about 1:6 and about 1:1, e.g., about 2:3.

In embodiments, a slurry discharge conduit is provided that is in fluid communication with the main mixer. In embodiments, the slurry discharge conduit can comprise any suitable discharge conduit component as will be appreciated by one skilled in the art. For example, the discharge conduit can include a delivery conduit, a foam injection body of the foam injection system, a flow-modifying element, and a slurry distributor.

In embodiments, the discharge conduit is in fluid communication with the main mixer and is configured to deliver a main flow of the core slurry from the main mixer downstream to a further manufacturing station. In embodiments, the discharge conduit is adapted to deposit the core slurry upon a web of cover sheet material advancing in a machine direction. In this arrangement, the gypsum board is produced “face down” such that the advancing web serves as the “face” cover sheet of the finished board. In embodiments, the core slurry can be discharged from the discharge conduit in an outlet flow direction substantially along the machine direction in which the moving face cover sheet is travelling.

In embodiments, the delivery conduit can be made from any suitable material and can have different shapes. In some embodiments, the delivery conduit can comprise a flexible conduit.

In embodiments, one or more flow-modifying elements can be associated with the discharge conduit and adapted to modify the flow of the core slurry discharged from the main mixer through the discharge conduit. In embodiments, the flow-modifying element is disposed downstream of the foam injection body and the aqueous foam supply conduit relative to a flow direction of the flow of cementitious slurry from the main mixer through the discharge conduit. The flow-modifying element(s) can be used to control an operating characteristic of the flow of the core slurry moving through the discharge conduit. Examples of suitable flow-modifying elements include volume restrictors, pressure reducers, constrictor valves, canisters etc., including those described in U.S. Patent Nos. 6,494,609; 6,874,930; 7,007,914; and 7,296,919, for example.

In embodiments, the slurry distributor can be any suitable terminal portion of a conventional discharge conduit, such as a length of conduit in the form of a flexible hose or a component commonly referred to as a “boot.” In embodiments, the boot can be in the form of a multi-leg discharge boot.

In yet other embodiments, the slurry distributor of the discharge conduit 112 can be similar to one as shown and described in U.S. Patent Application Publication Nos. 2012/0168527; 2012/0170403; 2013/0098268; 2013/0099027; 2013/0099418; 2013/0100759; 2013/0216717; 2013/0233880; and 2013/0308411, for example. In some of such embodiments, the discharge conduit can include suitable components for splitting a main flow of cementitious slurry from the main mixer into two flows which are re-combined in the slurry distributor.

In embodiments, a foam injection system is arranged with at least one of the main mixer and the slurry discharge conduit. The foam injection system can include a foam source (e.g., such as a foam generation system configured as known in the art), a foam supply conduit, and a suitable foam injection body.

In embodiments, any suitable foam source can be used. Preferably, the aqueous foam is produced in a continuous manner in which a stream of a mix of foaming agent and water is directed to a foam generator, and a stream of the resultant aqueous foam leaves the generator and is directed to and mixed with the cementitious slurry. In embodiments, any suitable foaming agent can be used. Some examples of suitable foaming agents are described in U.S. Patent Nos. 5,683,635 and 5,643,510, for example.

In embodiments, the aqueous foam supply conduit can be in fluid communication with at least one of the main mixer and the delivery conduit. An aqueous foam from the foam source can be added to the constituent materials through the foam supply conduit at any suitable location downstream of the main mixer in the discharge conduit and/or in the main mixer itself to form a foamed cementitious slurry. In the illustrated embodiment, the foam supply conduit is disposed downstream of the main mixer. In embodiments, the aqueous foam supply conduit has a manifold-type arrangement for supplying foam to a number of foam injection ports within the foam injection body, which can be in the form of an injection ring or block, associated with the discharge conduit, such as is described in U.S. Patent No. 6,874,930, for example.

In other embodiments, one or more secondary foam supply conduits can be provided, and each of which is in fluid communication with the main mixer. In yet other embodiments, the aqueous foam supply conduit(s) can be in fluid communication with the main mixer alone. As will be appreciated by those skilled in the art, the means for introducing aqueous foam into the gypsum slurry, including its relative location in the assembly, can be varied and/or optimized to provide a uniform dispersion of aqueous foam in the core slurry to produce board that is fit for its intended purpose.

In embodiments, the foam injection body comprises a part of at least one of the main mixer and the slurry discharge conduit. The illustrated foam injection body comprises a part of the discharge conduit.

In embodiments, one or both of the cover sheets of the gypsum board can be treated with a relatively denser layer of gypsum slurry (relative to the core slurry from which the board core is made), often referred to as a “skim coat” in the art, if desired. To that end, in embodiments, the main mixer can include an auxiliary conduit that is adapted to deposit a stream of dense aqueous cementitious slurry that is relatively denser than the core slurry deposited from the discharge conduit. In embodiments, the denser layer can be provided at the edges of the board, as well, using known equipment and techniques.

In embodiments, the auxiliary conduit comprises one for depositing a skim coat layer to a back cover sheet. The main mixer can direct a flow of aqueous calcined gypsum slurry through the auxiliary conduit (i.e., a “back skim coat stream”) that is relatively denser than the main flow of the foamed core slurry dispensed from the discharge conduit. A back skim coat station can include suitable equipment for applying the back skim coat, such as, for example, a back skim coat roller disposed over a support element such that the second cover sheet being dispensed from a second roll is disposed therebetween. The auxiliary conduit can deposit the back skim coat stream upon the moving second cover sheet upstream (in the direction of movement of the second cover sheet) of the back skim coat roller that is adapted to apply a skim coat layer to the second cover sheet being dispensed from the second roll as is known in the art.

In other embodiments, separate auxiliary conduits can be connected to the main mixer to deliver one or more separate streams to the face cover sheet. Other suitable equipment (such as auxiliary mixers) can be provided in the auxiliary conduits to help make the slurry therein denser, such as by mechanically breaking up foam in the slurry and/or by chemically breaking up the foam through use of a suitable de-foaming agent inserted into the auxiliary conduit(s) through a suitable inlet. In other embodiments, an auxiliary conduit can direct slurry from the main mixer into a second mixer and/or include a suitable inlet for incorporating at least one enhancing additive therein to form a strengthened slurry having at least one ingredient which is more concentrated in the strengthened slurry than in the core slurry to form a slurry suitable for use as a concentrated layer and/or as edge layer(s).

In embodiments, the wet end assembly 38 can be equipped with other conventional equipment as is known in the art. The wet end assembly 38 is configured to mix and assemble constituent materials together such that a continuous gypsum board having a predetermined nominal thickness can be produced from a forming station along a conveyor in the machine direction toward a cutting station. In embodiments, the system 12 for manufacturing a gypsum board can include other components and stations. For example, in embodiments, the system can include a transfer system, including a board inverter; a kiln; and a bundler and taping station, all downstream of the cutting station. In embodiments, the board manufacturing process can be completed using any suitable techniques and equipment which are known to those skilled in the art.

In embodiments, a method of manufacturing calcined gypsum or a method of manufacturing gypsum board following principles of the present disclosure can be performed using any suitable system for manufacturing calcined gypsum or system for manufacturing gypsum board constructed according to principles of the present disclosure. In embodiments of a method of manufacturing calcined gypsum or a method of manufacturing gypsum board following principles of the present disclosure, a system for manufacturing calcined gypsum and/or a system for manufacturing gypsum board constructed according to principles of the present disclosure is used to grind gypsum to an average particle size of fifteen microns or less.

For example, in embodiments, a method of manufacturing a gypsum board includes grinding a supply of calcined gypsum in a rotor mill such that a feed stream of ground calcined gypsum having an average particle size of fifteen microns or less is produced. The feed stream of ground calcined gypsum is delivered to a mixer. At least water and the feed stream of ground calcined gypsum is agitated in the mixer to form an aqueous gypsum slurry. In embodiments, grinding a supply of calcined gypsum in the rotor mill and delivering the feed stream of ground calcined gypsum to the mixer are performed substantially continuously. In embodiments, the supply of calcined gypsum is grinded in an impact mill upstream of the supply of calcined gypsum being ground in the rotor mill such that the supply of calcined gypsum has an average particle size in a range from twenty to fifty microns.

### EXAMPLES

### Example 1

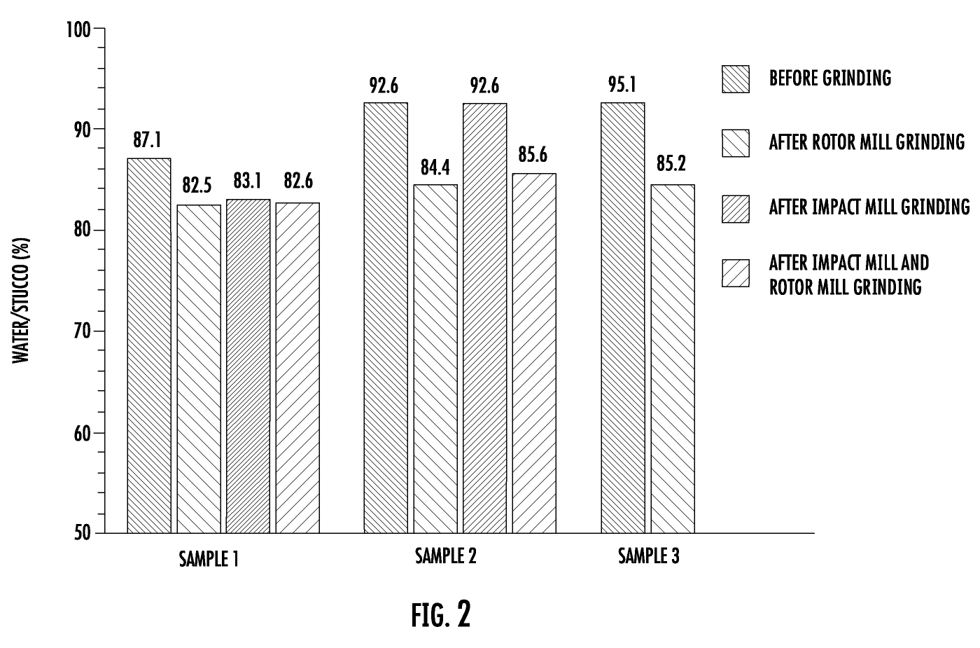

Referring to FIG. 2, different samples of gypsum slurry were processed using different grinding techniques. Sample 1 is a specimen of calcined gypsum from synthetic gypsum. Samples 2 and 3 are different specimens of calcined gypsum from natural gypsum. A “slump test” was conducted in each Sample under different grinding conditions as indicated in FIG. 2. The procedure for the gypsum slurry slump test is to fill with aqueous calcined gypsum slurry a two-inch diameter by four-inch long smooth walled brass or PVC cylinder placed on a board, lift the cylinder straight up, and then measure the diameter of the slurry patty spread out over the board. The larger the patty, the more fluidic the slurry is. The slump test data shown in FIG. 2 is the water/stucco ratio for each grinding condition to achieve a seven-inch diameter patty. Sample 1 showed increased stucco fluidity after being roller milled. Roller mill grinding of Samples 2 and 3 reduced the water demand of the stucco by 6-10%.

### Example 2

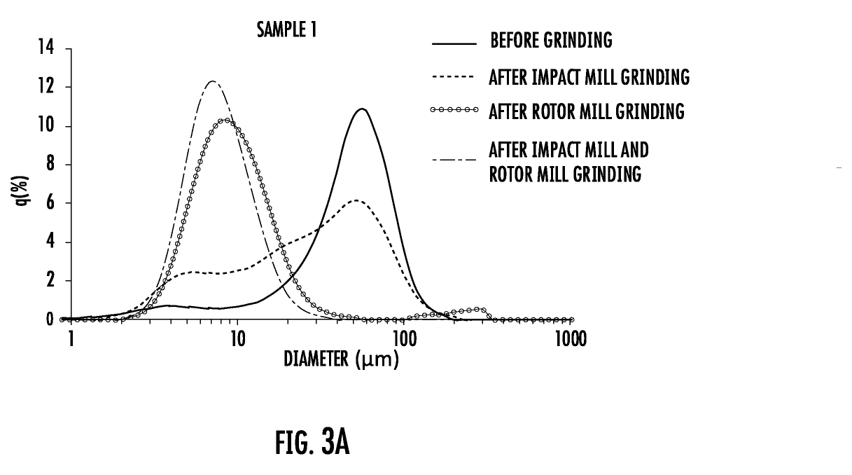

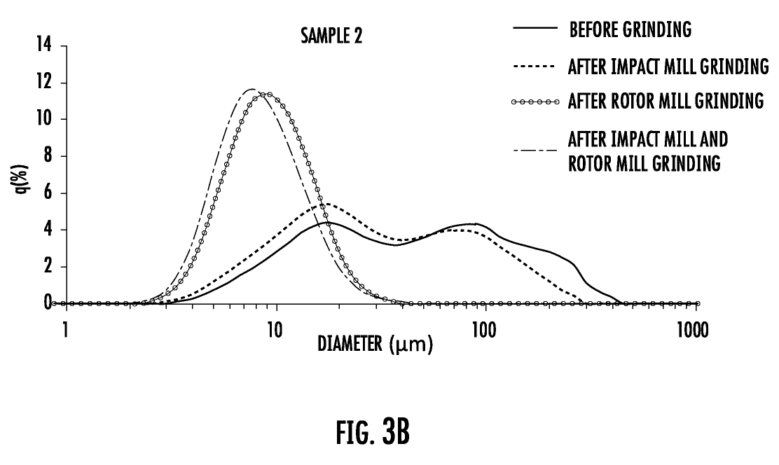

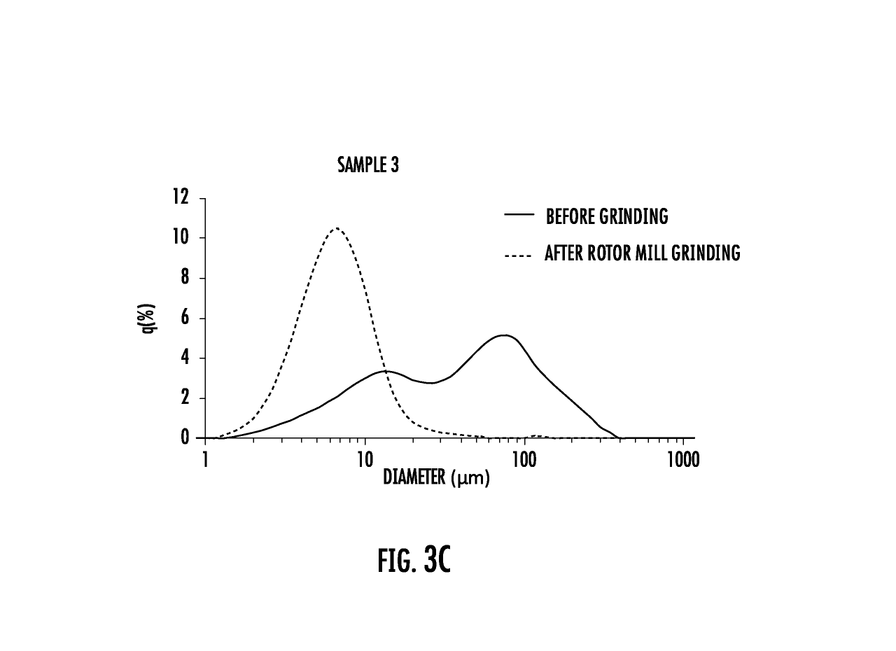

Referring to FIGS. 3A-C, the particle size distribution of Samples 1–3 of Example 1 is respectively shown under different grinding conditions. Samples 1–3 generally exhibited a bimodal distribution when unground. After roller mill grinding, Samples 1–3 generally exhibited a monomodal distribution with the average particle size being less than fifteen microns, and more than half of the particles being less than ten microns.

### Example 3

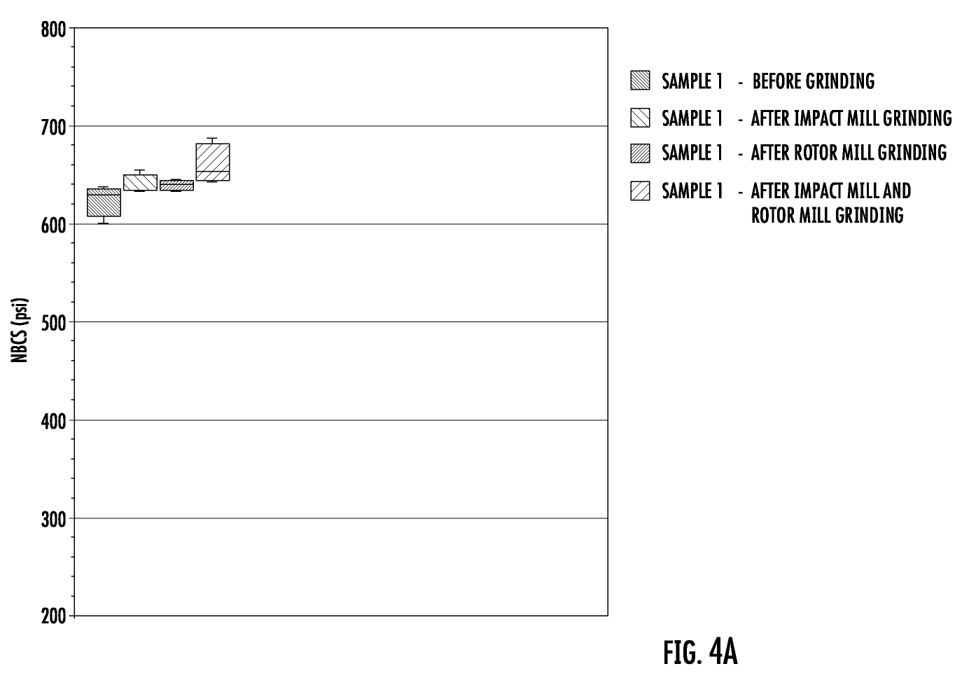

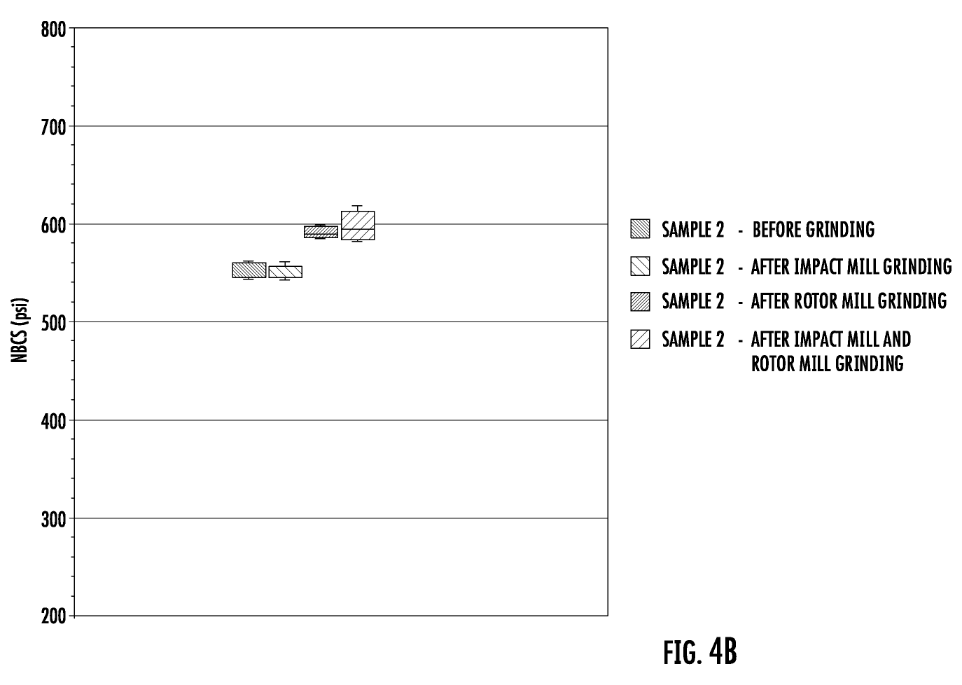

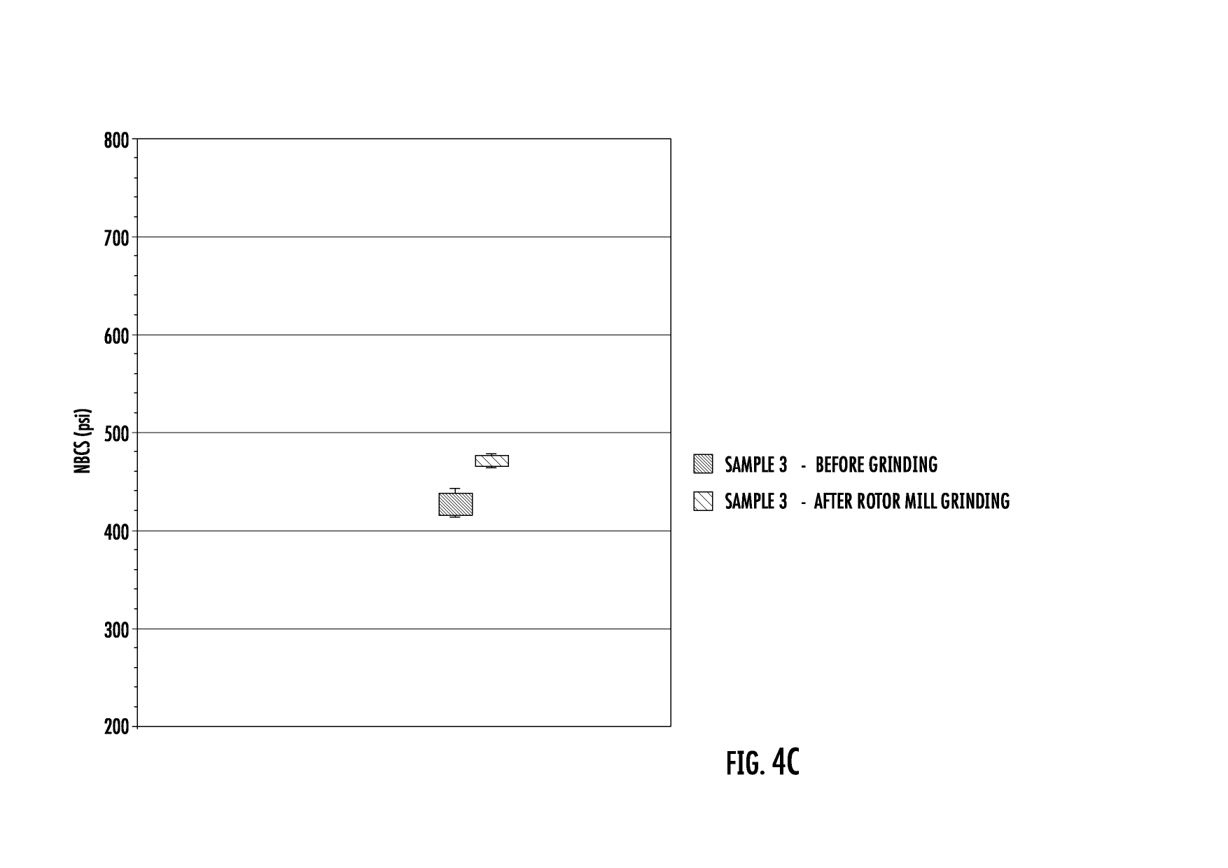

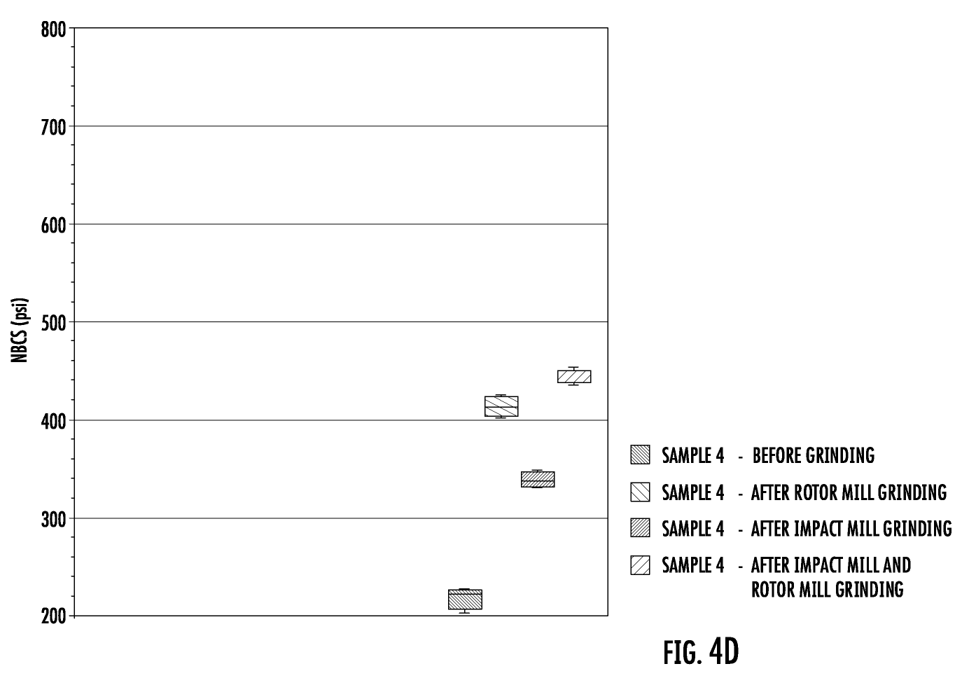

Referring to FIGS. 4A-D, the compressive strength of Samples 1–4 is respectively shown under different grinding conditions. Samples 1–3 are the same as those of Example 1. Sample 4 is the same as Sample 3 except that it was subjected to some spray on water and retarder according to principes described in U.S. Patent No. 8,566,041. The compressive strength of the Samples was evaluated according to principles described in U.S. Patent No. 7,588,634 with no foam added. The compressive strength of Samples 1–4 increased after roller mill grinding. The compressive strength of Samples 1–4 was greatest after being subjected to both roller mill grinding and impact mill grinding.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing calcined gypsum, the system comprising:
a calcination unit, the calcination unit including a calcining chamber and a heating unit associated with the calcining chamber, the calcining chamber including an inlet for receiving a supply of gypsum therethrough and into the calcining chamber and an outlet for discharging the supply of gypsum from the calcining chamber;
a grinding system, the grinding system including a rotor mill in at least one of a position upstream of the inlet of the calcining chamber and a position downstream of the outlet of the calcining chamber, and the rotor mill configured to grind the supply of gypsum to an average particle size of fifteen microns or less.

2. The system for manufacturing calcined gypsum according to claim 1, wherein the rotor mill is configured to grind the supply of gypsum such that the average particle size is in a range from five to fifteen microns.

3. The system for manufacturing calcined gypsum according to claim 1, wherein the rotor mill is configured to grind the supply of gypsum such that more than fifty percent of the gypsum particles are twelve microns or less.

4. The system for manufacturing calcined gypsum according to claim 1, wherein the grinding system is disposed downstream of the calcining chamber.

5. The system for manufacturing calcined gypsum according to claim 1, further comprising:
a feeder conveyor, the feeder conveyor configured to feed the supply of gypsum to the calcining chamber;
a source of gypsum, the source of gypsum associated with the feeder conveyor to selectively deliver the supply of gypsum to the feeder conveyor.

6. The system for manufacturing calcined gypsum according to claim 1, wherein the grinding system includes an impact mill, the impact mill connected in series to the rotor mill such that the supply of gypsum moves serially through the rotor mill and the impact mill.

7. The system for manufacturing calcined gypsum according to claim 6, wherein the impact mill is configured to grind the supply of gypsum to an average particle size of fifty microns or less.

8. The system for manufacturing calcined gypsum according to claim 7, wherein the impact mill is configured to grind the supply of gypsum such that the average particle size is in a range from twenty to fifty microns.

9. A system for manufacturing a gypsum board, the system comprising:
a mixer, the mixer being adapted to agitate calcined gypsum and water to form an aqueous gypsum slurry;
an ingredient supply system, the ingredient supply system being configured to selectively feed at least water and calcined gypsum to the mixer, the ingredient supply system including a source of calcined gypsum; and
a grinding system, the grinding system including a rotor mill interposed between the source of calcined gypsum and the mixer, the rotor mill configured to grind calcined gypsum from the source of calcined gypsum to an average particle size of fifteen microns or less to selectively deliver a feed stream of ground calcined gypsum to the mixer.

10. The system for manufacturing a gypsum board according to claim 9, wherein the rotor mill is configured to grind the supply of gypsum such that the average particle size is in a range from five to fifteen microns.

11. The system for manufacturing a gypsum board according to claim 9, wherein the rotor mill is configured to grind the supply of gypsum such that more than fifty percent of the gypsum particles are twelve microns or less.

12. The system for manufacturing a gypsum board according to claim 9, wherein the grinding system includes an impact mill, the impact mill connected in series to the rotor mill such that the supply of gypsum moves serially through the rotor mill and the impact mill.

13. The system for manufacturing a gypsum board according to claim 12, wherein the impact mill is configured to grind the supply of gypsum to an average particle size of fifty microns or less.

14. The system for manufacturing calcined gypsum according to claim 13, wherein the impact mill is configured to grind the supply of gypsum such that the average particle size is in a range from twenty to fifty microns.

15. The system for manufacturing a gypsum board according to claim 9, further comprising:
a calcination unit, the calcination unit including a calcining chamber and a heating unit associated with the calcining chamber, the calcining chamber including an inlet for receiving a supply of gypsum therethrough and into the calcining chamber and an outlet for discharging the source of calcined gypsum from the calcining chamber.

16. The system for manufacturing a gypsum board according to claim 15, wherein the grinding system includes an impact mill, the impact mill connected in series to the rotor mill such that the source of gypsum moves serially through the rotor mill and the impact mill.

17. The system for manufacturing a gypsum board according to claim 16, wherein the impact mill is upstream of the rotor mill, and the impact mill and the rotor mill are interposed between the calcining chamber and the mixer.

18. A method of manufacturing a gypsum board, the system comprising:
grinding a supply of calcined gypsum in a rotor mill such that a feed stream of ground calcined gypsum having an average particle size of fifteen microns or less is produced;
delivering the feed stream of ground calcined gypsum to a mixer;
agitating at least water and the feed stream of ground calcined gypsum in the mixer to form an aqueous gypsum slurry.

19. The method of claim 18, wherein grinding a supply of calcined gypsum in the rotor mill and delivering the feed stream of ground calcined gypsum to the mixer are performed substantially continuously.

20. The method of claim 18, further comprising:
upstream of the supply of calcined gypsum being ground in the rotor mill, grinding the supply of calcined gypsum in an impact mill such that the supply of calcined gypsum has an average particle size in a range from twenty to fifty microns.
